(19) United States
(12) Patent Application Publication
(10) Pub. No.: US 2003/0058826 A1
(43) Pub. Date: Mar. 27, 2003

(54) Multihop, multi-channel, wireless communication network with scheduled time slots

(76) Inventor: Daniel D. M. Shearer III, Scottsdale, AZ (US)

Correspondence Address: LOWELL W. GRESHAM, ESQ., MESCHKOW & GRESHAM, P.L.C., Suite 409, 5727 North Seventh Street, Phoenix, AZ, 85014, US

(21) Appl. No.: 10/004,548

(22) Filed: Dec. 4, 2001

Related U.S. Application Data
(60) Provisional application No. 60/324,501, filed on Sep. 24, 2001.

(51) Int. Cl. H04Q 7/24; H04B 7/212

(52) U.S. Cl. 370/338; 370/442

(57) ABSTRACT

A wireless local area network (20) includes a hub access point node (22), any number of active nodes (24) and any number of inactive nodes (26). Some of the active nodes (24) act as forwarding nodes (32) so that the coverage area of the network (20) is extended beyond the radio range of the hub access point node (22). Time slots (42) are consecutively scheduled for the active nodes (24) along outward communication paths (34) and inward communication paths (36). Beginning time slots (42) for the inward communication paths (36) are assigned to outermost nodes (38) in the paths (36). Beginning time slots (42) for the outward communication paths (34) are assigned to the hub access point node (22). Time slots (42) are assigned in a manner that minimizes total latency (44). Time slots (42) are also assign to afford opportunities for the inactive nodes (26) to communicate.

### RELATED INVENTION

The present invention claims priority under 35 U.S.C. §119(e) to: “Multihop Cellular Frequency Plan,” Provisional U.S. Patent Application Serial No. 60/324,501, filed Sep. 24, 2001, which is incorporated by reference herein.

The present invention is related to the U.S. patent application entitled “Forwarding Communication Network And Wireless Channel Allocation Method Therefor,” Attorney Docket No. 2277-050, Ser. No. ______, by the inventor hereof and filed on even date herewith, which is incorporated by reference herein.

### TECHNICAL FIELD OF THE INVENTION

The present invention relates generally to the field of communication networks. More specifically, the present invention relates to the field of multihop, multi-channel, wireless communication networks.

### BACKGROUND OF THE INVENTION

Wireless local area networks (WLANs) are highly desirable communication networks because they do not suffer from the costs of installing cables and they permit greater flexibility in locating and moving communication equipment. However, WLANs often use the radio portion of the electromagnetic spectrum to effect communications, and the radio portion of the electromagnetic spectrum is a scarce, regulated resource. Many use the electromagnetic spectrum in a manner that requires obtaining the appropriate governmental licenses. A requirement for obtaining governmental licenses is undesirable because of the high costs and administrative burdens involved.

Unlicensed portions of the electromagnetic spectrum are available (e.g., at 0.9, 2.4, and 5 GHz) so long as the equipment using the unlicensed spectrum transmits signals at a specified, very low power level and meets other criteria. At this very low power level, each transmission has only a very short radio range. Due to this short range, if conventional cellular or ad-hoc networking techniques were used, an excessive number of hubs would be required to provide communication services over a given area. A lower number of hubs would be more desirable because hubs are typically wire-connected to another network, such as the Public Switched Telecommunications Network (PSTN) or Internet, and hubs typically represent overhead costs.

The related patent entitled “Connectionless Communication Network And Wireless Channel Allocation Method Therefor” (see above) describes a multihop, multi-channel, WLAN through which customer premises equipment (CPE) nodes communicate with a parent network, such as the Internet, in a manner consistent with the provisions of the 802.11 standard set forth by Institute of Electrical and Electronics Engineers, Inc. (IEEE). A hub contains an access point connected to the parent network. CPEs wishing to send and receive data over that parent network pass data communications through the hub. Forwarding nodes have the capability to forward data from CPE nodes that are farther away from the hub to forwarding nodes closer to the hub, or to the hub itself if within radio range. Likewise, forwarding nodes can forward data to nodes located farther away from the hub. Thus, forwarding nodes act as access points with respect to nodes located farther away from the hub. Forwarding nodes may also serve as CPEs.

The transfer of data from one node to another is called a hop. With each hop, data flowing from a CPE toward the hub should be transferred to a node that is one hop closer to the hub. Data flowing from the hub should reverse that path. A first hop that conveys data either to or from the hub uses a first channel, a second hop uses a second channel so as not to interfere with the first channel, and so on. At some point, channels may be reused when the interference distance has been reached, which in a typical scenario may be around three hops. Such a multihop, multi-channel WLAN allows fewer hubs to achieve coverage in a given area than would be required using traditional cellular or ad-hoc networking techniques.

The IEEE 802.11 standard, like the well-known IEEE 802.3 Ethernet standard for wired networks, contemplates unscheduled access to the conveyance medium (e.g., cable or airwaves). Generally, a first node wishing to transmit monitors the medium to determine whether another node is transmitting at that instant. If no other node is transmitting, then the medium is deemed clear, and the first node transmits an initial message. However, a second node may be undergoing the same process at around the same time, both the first and second nodes may concurrently conclude that the medium is clear, and both may transmit initial messages concurrently, resulting in a collision.

When a collision occurs, neither initial message is successfully received by its intended target. When a collision occurs, the first and second nodes desirably backoff for a random period of time, then attempt their initial message transmissions again. The initial messages may be in the form of a Request-To-Send (RTS) message, and the intended target may signal its successful receipt thereof by transmitting a Clear-To-Send (CTS) message which serves both to indicate successful receipt and to inhibit other nodes from attempting to access the medium for a while so that the initiating node may then transmit more data with less risk of collisions.

The collision/backoff periods and the CTS/RTS overhead messages represent examples of inefficiencies in which the medium time is not used to convey user data. Nevertheless, this unscheduled access technique works well when network traffic is low and few collisions occur. However, with increasing traffic, at some point the collision/backoff and CTS/RTS overhead become burdensome.

In a multihop, multi-channel WLAN, the innermost channel may convey all traffic for all nodes in the WLAN, the next innermost channel conveys all traffic except for the nodes that communicate with the hub using only one hop, and so on. When viewing the WLAN from the outermost channel inward, each channel carries more traffic than the channels located farther outward. Consequently, the innermost channel can be a bottleneck and can occasionally expect sufficiently high data traffic that the conventional unscheduled access techniques are undesirably burdensome.

Moreover, since the outer channels experience less data traffic, little impedes data flowing inward from the outer nodes from reaching a forwarding node, then piling up at the forwarding node (i.e., being buffered) until time may be found co forward the data to the hub. The requirement for large buffers in forwarding nodes is undesirable for several reasons.

First, large buffers are undesirable due to increased latency. Latency describes the duration required for data to flow from its originating point to its terminating point. A continuous need exists for networks to minimize latency, and the more time data spends being buffered, rather than moving toward its termination point, the worse the latency.

Another problem with a requirement for large buffers is a dramatic increase in memory costs of forwarding nodes, particularly when high data rates are involved. At high data rates, (e.g., 0.125 Mbps or more), buffering data for even a few milliseconds can require the use of an excessive amount of memory. Yet another problem is that the quality of service diminishes as latency increases. Generally, the more data being held by the network at any given instant the greater the risk that some of the data will fail to reach their intended termination points, and the worse the quality of service.

Accordingly, a need exists for a multihop, multi-channel WLAN in which media access is scheduled to reduce latency and improve overall efficiency.

### SUMMARY OF THE INVENTION

It is an advantage of the present invention that an improved multihop, multi-channel, wireless communication network with scheduled time slots is provided.

Another advantage of the present invention is that a multihop, multi-channel, wireless communication network is provided which, to a large extent, avoids the inefficiencies of unscheduled access.

Yet another advantage of the present invention is that a multihop, multi-channel, wireless communication network is provided that schedules time slots to minimized latency.

Still another advantage of the present invention is that a multihop, multi-channel, wireless communication network is provided that schedules time slots consecutively along communication paths.

Still another advantage of the present invention it that a multihop, multi-channel, wireless communication network is provided that schedules time slots for identified active nodes while allocating unscheduled time slots for use by unidentified inactive nodes.

These and other advantages are realized in one form by an improved multihop, multi-channel, wireless communication network configured as a daughter network for coupling to a parent network. The communication network includes a hub access-point (HAP) node configured to be coupled to the parent network and configured to engage in outward wireless communication. A plurality of active nodes are also configured to engage in outward wireless communication with the HAP node over a plurality of outward communication paths. The plurality of outward communication paths each includes at least two outward hops and uses at least two channels. Scheduled time slots are allocated to the active nodes for transmitting data packets over the plurality of outward communication paths. One time slot is associated with each outward hop, and the time slots are consecutively arranged along the plurality of outward communication paths.

The above and other advantages are realized in another form by a method of allocating resources that is carried out in a communication network where a hub access-point (HAP) node communicates with a plurality of active nodes over a plurality of communication paths, and the plurality of communication paths includes at least two hops and uses at least two channels. The method allocates resources to the active nodes for use in forming the communication paths and calls for collecting identity data which describes every hop of each communication path. Those ones of the communication paths having common first hops are associated together in first-hop sets, and within each of said first-hop sets, ones of the communication paths having common second hops are associated together to form second-hop sets. The first-hop and second-hop sets are then disassociated, and time slots are assigned to the active nodes so that one time slot is associated with each hop. The time slots are consecutively arranged along the communication paths. Allocation data is sent to the active nodes, where the allocation data identifies assignments of the time slots to the active nodes.

The above and other advantages are realized in another form by a resource allocation computer program for use with a multihop, multi-channel, wireless communication network, where a hub access-point (HAP) node communicates with a plurality of active nodes over a plurality of communication paths, and wherein each of the plurality of communication paths includes at least two hops and uses at least two channels. The computer program includes first through fifth program segments. The first program segment is configured to collect identity data which describes every hop of each communication path. The second program segment is configured to sort the communication paths so that the communication paths having common first hops are associated together in first-hop sets, and within each of the first-hop sets, the paths having common second hops are associated together to form second-hop sets. The third program segment is configured to interleave the first-hop sets and the second-hop sets. The fourth program segment is configured to assign time slots to the active nodes so that one time slot is associated with each hop, and the time slots are consecutively arranged along the communication paths The fifth program segment is configured to send allocation data to the active nodes, where the allocation data identifies assignments of the time slots to the active nodes. The first through fifth program segments are embodied in a computer-readable medium.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic layout drawing of a multihop, multi-channel, wireless local area network (WLAN) configured in accordance with the teaching of the present invention;

FIG. 2 shows a schematic layout drawing of the multihop, multi-channel WLAN of FIG. 1 depicting exemplary inward and outward communication paths;

FIG. 3 shows a schematic layout drawing of the multihop, multi-channel WLAN depicting four exemplary outward communication paths that share a common hop;

FIG. 4 shows a timing diagram that depicts the non-interfering allocation of time slots to active nodes for one exemplary inward communication path and one exemplary outward communication path in the multihop, multi-channel WLAN;

FIG. 5 shows a timing diagram that depicts the non-interfering allocation of time slots to active nodes for one exemplary inward and two exemplary outward communication paths in the multihop, multi-channel WLAN;

FIG. 6 shows a timing diagram that depicts the interfering allocation of time slots to active nodes for one exemplary inward communication path and one exemplary outward communication path in the multihop, multi-channel WLAN;

FIG. 7 shows a block diagram of an exemplary node usable in the multihop, multi-channel WLAN of FIG. 1;

FIG. 8 shows a flow chart depicting a resource allocation process carried out in the multihop, multi-channel WLAN;

FIG. 9 shows a table depicting bi-directional path pairs as set forth in a first stage of an allocation process;

FIG. 10 shows a table depicting bi-directional path pairs as set forth in a second stage of the allocation process;

FIG. 11 shows a table depicting bi-directional path pairs as set forth in a third stage of the allocation process;

FIG. 12 shows a table depicting inward and outward communication paths as set forth in a fourth stage of the allocation process;

FIG. 13 shows a table depicting inward and outward communication paths as set forth in a fifth stage of the allocation process;

FIG. 14 shows a table depicting inward and outward communication paths as set forth in a sixth stage of the allocation process;

FIG. 15 shows a table depicting inward and outward communication paths as set forth in a seventh stage of the allocation process; and

FIG. 16 shows a table depicting inward and outward communication paths as set forth in an eighth stage of the allocation process.

### DETAILED DESCRIPTION OF THE PREFERRED EMBODIMENTS

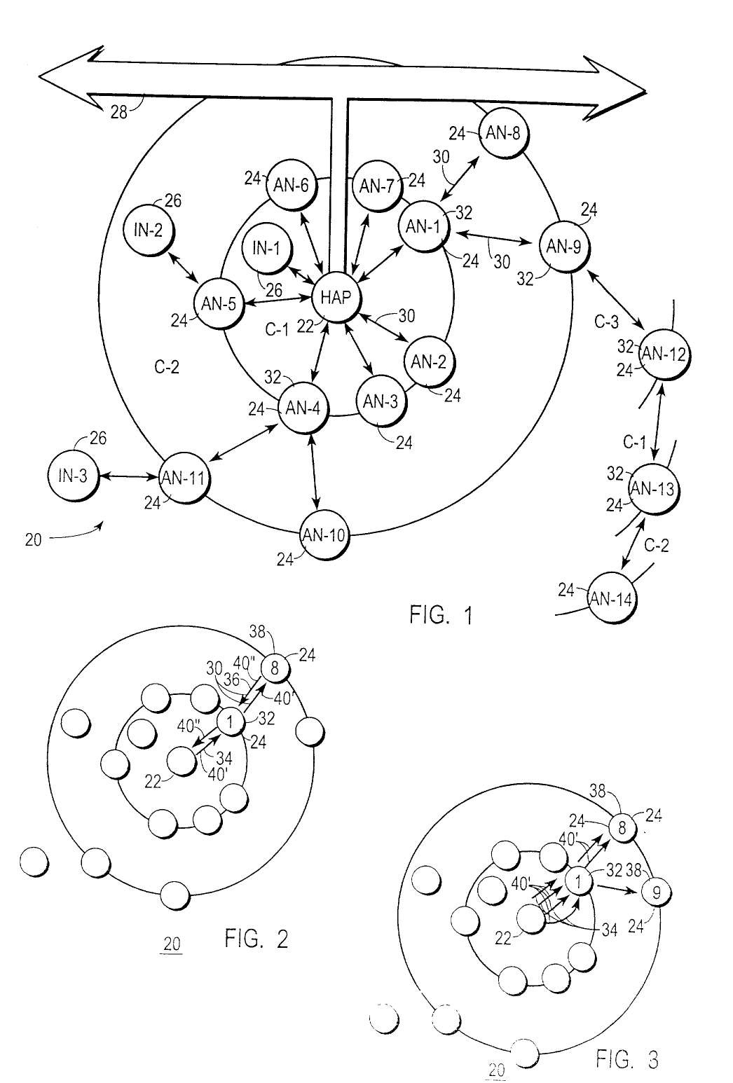

FIG. 1 shows a schematic layout drawing of a multihop, multi-channel, wireless local area network (WLAN) 20 configured in accordance with the teaching of the present invention. WLAN 20 includes a hub access point (HAP) node 22, any number of active nodes 24 and any number of inactive nodes 26. FIG. 1 schematically depicts only one of a multiplicity of different nodal configurations for purposes of illustration and labels fourteen active nodes 24 with the notation AN-1 through AN-14 and three inactive nodes 26 with the notation IN-1 through IN-3. As will be discussed in greater detail below, active nodes 24 differ from inactive nodes 26 in that time slots have been, or are being, scheduled for active nodes 24. Scheduling refers to reserving specifically identified time slots for use at specifically identified nodes. Inactive nodes 26 may communicate during time slots scheduled at HAP node 22 and at active nodes 24 for that purpose.

WLAN 20 is configured as a daughter network that couples to a parent network 28, such as the Internet. The coupling between WLAN 20 and parent network 28 occurs at HAP node 22 and may take place through a wired or wireless connection. The majority of data traffic for each active node 24 and inactive node 26 is expected to flow to and from parent network 28 through HAP 22. Desirably, HAP 22 is configured with sufficient capacity to handle all data traffic flowing in WLAN All of nodes 22, 24, and 26 communicate with other nodes within WLAN 20 via radio frequency communication links, referred to as bi-directional path pairs 30 herein. In the preferred embodiment, all nodes 22, 24, and 26 are configured in a manner compatible with an 802.11 standard promulgated by the Institute of Electrical and Electronics Engineers, Inc. (IEEE), while possessing other capabilities discussed in more detail below. Thus, nodes 22, 24, and 26 of WLAN 20 preferably communicate with one another using very low power transmissions over unlicensed portions of the radio spectrum. Due to the low power transmissions, the maximum radio range of signals transmitted from any one node 22, 24, or 26 may be relatively short (e.g., 300 m). In order to reduce the number of HAP nodes 22 required when a plurality of WLANs 20 are employed to cover a larger area, each HAP node 22 and WLAN 20 supports an area larger than can be covered by the radio range of signals transmitted from HAP node 22. The increase in coverage area for WLAN 20 beyond the radio range of HAP 22 is accomplished by having at least some of active nodes 24 serving as forwarding nodes 32.

Forwarding nodes 32 forward data in an inward direction toward HAP node 22 and in an outward direction away from HAP node 22. The transfer of data from one node 22, 24, 26 to another is called a hop. Nodes 24 and 26 located only one hop away from HAP node 22 communicate directly over bi-directional path pairs 30 with HAP node 22 using a first common channel, labeled C-1 in FIG. 1. The spectrum utilized by WLAN 20 may be channeled using frequency, coding, and/or spatial techniques well known to those skilled in the art. Channel C-1 is used for inward communication and outward communication and is shared by HAP node 22 and all nodes 24 and 26 located one hop away from HAP node 22.

Forwarding nodes 32 located one hop away from HAP node 22 (e.g., AN-1) communicate with other nodes 24 and 26 located further outward from HAP node 22 (e.g., AN-8 and AN-9) using a second common channel, labeled C-2 in FIG. 1. Channel C-2 is used adjacent to channel C-1 to prevent mutual interference. These other nodes 24 and 26 that can communicate with the one-hop forwarding nodes 32 are two-hop nodes because they are located two hops away from HAP node 22. Thus, the one-hop forwarding nodes 32 receive inward hops using channel C-2, transmit inward hops using channel C-1, receive outward hops using channel C-1, and transmit outward hops using channel C-2.

Likewise, forwarding nodes 32 located two hops away from HAP node 22 (e.g., AN-9) communicate with other nodes 24 and 26 located further outward from HAP node 22 (e.g., AN-12) using a third common channel, labeled C-3 in FIG. 1. Channel C-3 is used within radio range of nodes that transmit on channels C-1 and C-2 to prevent mutual interference. This forwarding pattern may continue for any number of hops, although practical considerations discussed below will usually limit the number of hops to only a few. For convenience, FIG. 1 depicts only one three-hop node 24 (AN-12), only one four-hop node 22 (AN-13) and only one five-hop node 24 (AN-14). However, nothing limits the number of nodes 24 and 26 that may be located any particular number of hops away from HAP node 22. FIG. 1 shows that channels may be reused at a distance sufficiently remote from other uses of the same channel so that interference is unlikely. Thus, three-hop nodes and four-hop nodes may communicate with one another using channel C-1, and four-hop nodes and five-hop nodes may communicate with each other using channel C-2.

One feature of WLAN 20 is that substantially all data flowing in WLAN 20 may pass through HAP node 22 using the innermost occurrence of channel C-1. This feature results because this innermost occurrence of channel C-1 handles all data traffic for one-hop nodes 24 and 26, plus all data traffic for two-hop nodes 24 and 26 forwarded through the one-hop forwarding nodes 32, plus all data traffic for three-hop nodes 24 and 26 forwarded through the two-hop and one-hop forwarding nodes 32, and so on. At times of moderate or heavy data traffic loads, the use of conventional IEEE 802.11 access techniques would be likely to result in undesirably high latency periods. Accordingly, time slots are scheduled as discussed below to reduce latency periods and improve efficiency.

Those skilled in the art will appreciate that while FIG. 1 schematically depicts substantially uniform radio ranges and hop distances, this uniformity need not be realized in WLAN 20. Moreover, the inward and outward directions are logical rather than physical directions. In some instances, a physically closer located node 24 or 26 may be prevented from being a one-hop node due only to the unfortunate placement of an obstruction. However, the physically closer node 24 or 26 may nevertheless communicate with HAP node 22 through a farther physically located one-hop forwarding node 32. This would make the physically closer node 24 or 26 a two-hop node regardless of its physical location. Additionally, as depicted in FIG. 1, WLAN 20 may include any number of one-hop nodes that convey communications to and from HAP node 22 using only a single channel. However, a WLAN 20 made only from one-hop nodes is a trivial configuration that would not suffer from the problems presented by a WLAN 20 having a plurality of at least two-hop nodes 24 and 26 which use at least two different channels in conveying communications to and from HAP node 22. Accordingly, the following discussion assumes that WLAN 20 includes a plurality of at least two-hop nodes 24 and 26 which use at least two different channels.

FIG. 2 shows a schematic layout drawing of multihop, multi-channel WLAN 20 depicting an exemplary outward communication path 34 and inward communication path 36. For convenience, FIG. 2 depicts the same layout illustrated in FIG. 1, except that three-, four-, and five-hop nodes AN-12 through AN-14 (FIG. 1) have been omitted. Each active node 24 communicates with HAP node 22 over one or more communication paths. Paths that extend from HAP node 22 to an outermost node 38 in the path are outward communication paths 34 over which data flows from HAP 22. Paths that extend from an outermost node 38 in the path are inward communication paths 36 over which data flows toward HAP 22.

For the sake of clarity, FIG. 2 illustrates a single bi-directional path pair 30. A bi-directional path pair 30 has outward and inward communication paths 34 and 36 that share a common outermost node 38. The bi-directional path pair 30 exists for the benefit of its outermost node 38. Each communication path 34 and 36 includes one or more hops 40. For outward communication paths 34, the hops 40 are outward hops 40′, and for inward communication paths 36, the hops 40 are inward hops 40″. Each hop 40 has two termini, with at least one of the two termini being at an active node 24. The other of the two termini may be at either HAP node 22, an active node 24, or an inactive node 26. While not shown in FIG. 2, each active node 24 in WLAN 20 serves as an outermost node 38 for a bi-directional path pair 30.

FIG. 3 shows a schematic layout drawing of multihop, multi-channel WLAN 20 depicting four exemplary outward communication paths 34 that have a common outward hop 40′. For convenience, FIG. 3 depicts the same layout illustrated in FIG. 1, except that three-, four-, and five-hop nodes AN-12 through AN-14 (FIG. 1) have been omitted. Inward communication paths 36 are omitted for the sake of clarity but may otherwise be present as shown in FIG. 2. For a first outward communication path 34, the outermost node 38 is the one-hop active node 24 labeled with a “1” in FIG. 3, (i.e., AN-1).

For a second outward communication path 34, the outermost node 38 is the two-hop active node 24 labeled with a “9”. This second outward communication path 34 shares a common innermost outward hop 40′ and active node “1” with the first outward communication path 34. However, for the first outward communication path 34, active node “1” is the destination for data traffic, while for the second outward communication path 34, active node “1” serves as a forwarding node 32. For the second outward communication path 34, active node “9” is the destination for data traffic.

For both of the third and fourth outward communication paths 34, the outermost node 38 is the two-hop active node 24 labeled with an “8”. Thus, duplicate communication paths may traverse the same nodes and have the same outermost node 38. The third and fourth outward communication paths 34 share the common innermost outward hop 40′ and active node “1” with the first and second outward communication paths 34. For the third and fourth outward communication paths 34, active node “1” serves as a forwarding node 32, and active node “8” is the destination for data traffic.

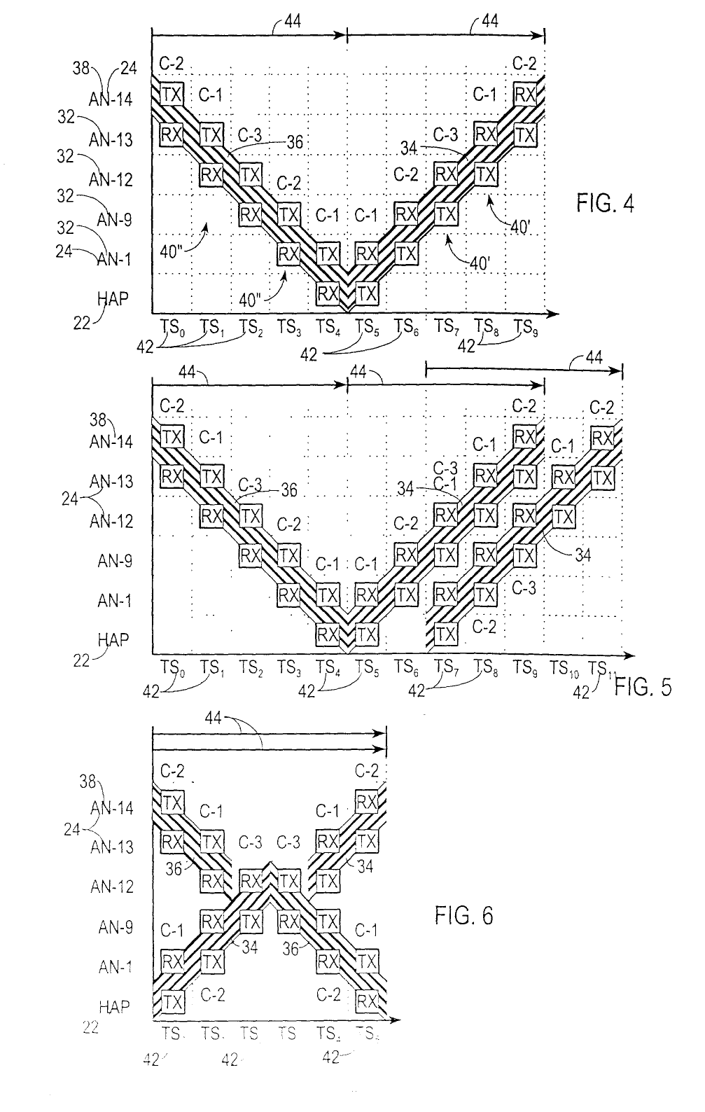

FIGS. 4-6 each show a timing diagram that depicts the exemplary allocation of time slots 42 to HAP node 22 and to active nodes 24. For the examples depicted in FIGS. 4-6, time slots 42 are allocated along bi-directional path pairs 30 (FIG. 2) that have an outermost active node 38 (FIGS. 2-3) of AN-14 (FIG. 1). Along these bi-directional path pairs 30, the active nodes 24 labeled AN-1, AN-9, AN-12, and AN-13 in FIG. 1 act as forwarding nodes 32.

FIG. 4 shows a timing diagram that depicts the non-interfering allocation of time slots 42 for one inward communication path 36 and for one outward communication path 34. In accordance with a preferred embodiment of the present invention, time slots 42 are consecutively arranged along inward and outward communication paths 36 and 34. In particular, one time slot 42 is assigned per hop 40 (FIG. 2), and time slots 42 are assigned in hop-order within communication paths 34 and 36. Thus, inward communication path 36 begins at the beginning of a time slot TS₀ and exists for a latency period 44 of five time slots 42, until the end of time slot TS₄. Outward communication path 34 begins at the beginning of time slot TS₅ and exists for a latency period 44 of five time slots 42, until the end of time slot TS₉. The outermost node 38 (i.e., AN-14) is a 5-hop active node 24, one time slot is allocated per hop, and latency period 44 for each of communication paths 34 and 36 is five time slots 42 in duration. A latency period of five time slots 42 for a five-hop communication path 34 or 36 is the minimum latency period and indicates that no data resides in buffers within forwarding nodes 32 for longer than a single time slot 42.

More specifically, a first inward hop 40″ in inward communication path 36 occurs when node AN-14 transmits over channel C-2 and node AN-13 receives the transmission during time slot TS₀. In the immediately following time slot TS₁, the second inward hop 40″ is scheduled, in which node AN-13 transmits over channel C-1 and node AN-12 receives the transmission. In time slot TS₂, which immediately follows time slot TS₁, the third inward hop 40″ is scheduled, in which node AN-12 transmits over channel C-3 and node AN-9 receives the transmission. In time slot TS₃, which immediately follows time slot TS₂, the fourth inward hop 40″ is scheduled, in which node AN-9 transmits over channel C-2 and node AN-1 receives the transmission. Finally, in time slot TS₄ which immediately follows time slot TS₃, the fifth inward hop 40″ is scheduled, in which node AN-1 transmits over channel C-1 and HAP node 22 receives the transmission. Thus, time slots 42 are consecutively arranged along inward communication path 36.

Desirably, inward communication path 36 and outward communication path 34 do not coexist so that the two paths do not interfere with one another. Thus, outward communication path 34 begins at node 22 some time after time slot TS₄ and at a point in time that will allow outward communication path 34 to end prior to the next beginning of inward communication path 36. Time slot TS₅ meets these requirements.

In outward communication path 34, a first outward hop 40′ occurs when HAP node 22 transmits over channel C-1 and node AN-1 receives the transmission during time slot TS₅. In the immediately following time slot TS₆, the second outward hop 40′ is scheduled, in which node AN-1 transmits over channel C-2 and node AN-9 receives the transmission. In time slot TS₇, which immediately follows time slot TS₆, the third outward hop 40′ is scheduled, in which node AN-9 transmits over channel C-3 and node AN-12 receives the transmission. In time slot TS₈, which immediately follows time slot TS₇, the fourth outward hop 40′ is scheduled, in which node AN-12 transmits over channel C-1 and node AN-13 receives the transmission. Finally, in time slot TS₉ which immediately follows time slot TS₈, the fifth outward hop 40′ is scheduled, in which node AN-13 transmits over channel C-2 and node AN-14 receives the transmission. Thus, time slots 42 are consecutively arranged along outward communication path 34.

FIG. 5 shows a timing diagram that depicts the non-interfering allocation of time slots 42 for one inward communication path 36 and for two outward communication paths 34. Each of the communication paths 34 and 36 traverses the same nodes (i.e., HAP, AN-1, AN-9, AN-12, AN-13, and AN-14). The arrangement of FIG. 5 differs from the FIG. 4 arrangement in that a second outward communication path 34 has been added. This second outward communication path 34 begins at HAP node 22 in time slot TS₇, exists through time slot TS₁₁, and demonstrates the minimum latency period 44 of five time slots 42. As shown in FIG. 5, the consecutive arrangement of timeslots 42 along communication paths 34 and 36 allows two paths extending in the same direction and having the same outermost node 38 to coexist without interference. Interference is avoided because no node is required to transmit and receive at the same time, to receive on two different channels at the same time, or to transmit on two different channels at the same time.

FIG. 5 demonstrates that additional capacity may be provided by assigning additional paths. Moreover, FIG. 5 demonstrates that asymmetrical capacity may be provided by having more paths in one direction than are provided in the other direction. Although not shown, other outward communication paths 34 may coexist with the two outward communication paths 34 shown in FIG. 5 without interference if begun at HAP node 22 in time slots TS₉ and/or TS₁₁. Likewise, other inward communication paths 36 may coexist with the inward communication path 36 shown in FIG. 5 without interference if arranged to end at HAP node 22 in time slots TS₂ or TS₀.

FIG. 6 shows a timing diagram that depicts the interfering allocation of time slots 42 for an outward communication path 34 and an inward communication path 36 which form a single bi-directional path pair 30. FIG. 6 differs from FIG. 4 in that outward communication path 34 and inward communication path 36 have been arranged to coexist. In the example depicted in FIG. 6, outward communication path 34 begins at HAP node 22 in time slot TS₀ and inward communication path 36 begins at outermost node 38 (i.e., AN-14) in time slot TS₀. An interference situation results where nodes AN-9 and AN-12 would be required to both transmit and receive in time slot TS₂ in order to maintain the consecutive arrangement of time slots 42 along communication paths 34 and 36. In order to compensate for the interference situation, the desirable attribute of consecutive arrangement of time slots along communication paths 34 and 36 is relaxed and another time slot is added. Thus, the latency periods 44 for communication paths 34 and 36 are now six time slots 42, with each communication path 34 and 36 existing from time slot TS₀ through time slot TS₅.

In this interfering situation, data received at node AN-12 along inward communication path 36 during time slot TS₁ cannot be transmitted from node AN-12 until time slot TS₃ because node AN-12 receives data in outward communication path 34 during time slot TS₂. Thus, data received during time slot TS₁ is buffered for approximately two time slots 42 before being forwarded along inward communication path 36. Likewise, data received at node AN-12 along outward communication path 34 during time slot TS₂ cannot be transmitted from node AN-12 until time slot TS₄ because node AN-12 transmits data in inward communication path 36 during time slot TS₃. Data received during time slot TS₂ is buffered for approximately two time slots 42 before being forwarded along outward communication path 34.

In allocating time slots 42 to active nodes 24, interfering situations, such as the one depicted in FIG. 6, are desirably avoided because they lead to increased latency. However, due to routing complexities presented by various nodal configurations of WLAN 20 (FIG. 1), not all interfering situations can be avoided. Thus, interfering situations are desirably minimized as much as practical.

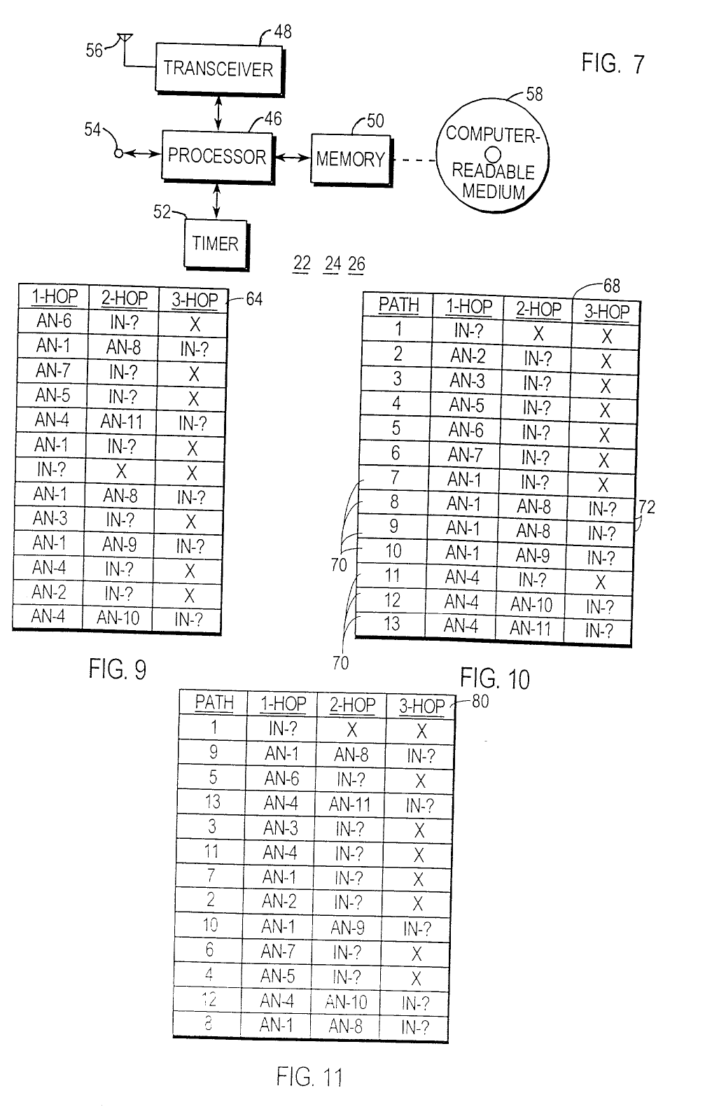

FIG. 7 shows a block diagram of an exemplary node 22, 24 or 26 usable in WLAN 20. Each node 22, 24 or 26 desirably includes a processor 46, which couples to a transceiver 48, a memory 50, a timer 52, and a data port 54.

In one preferred embodiment, only a single transceiver 48 is included to reduce costs, including hardware costs and costs associated with minimizing cross-talk. Transceiver 48 may transmit and receive communication signals through a single antenna 56. A consequence of using only a single transceiver 48 is that each node can either transmit or receive over only a single channel during a given time slot 42 (FIGS. 4-6). As discussed above, during the course of normal operations each forwarding node 32 is required to both transmit and receive over two different channels, for a total of four different operations. A resource allocation process discussed below is configured to allocate time slots 42 to active nodes 24 without requiring a transceiver 48 to engage in any two operations during any one time slot. Processor 46 controls transceiver 48 by specifying a transmit/receive direction of operation, a channel over which to communicate, and when to commence transmitting and receiving. Desirably, transceiver 48 is configured to transmit and receive over more than two different channels, although not simultaneously, so that channels may be reassigned within WLAN 20 from time to time as needed.

Timer 52 is used by processor 46 to manage time slots 42 (FIGS. 4-6). In a preferred embodiment which is compatible with an IEEE 802.11 standard, HAP node 22 may broadcast a count that serves as a clock signal for WLAN 20 and time slot length data which are propagated to all other nodes 24 and 26 in WLAN 20. Each node 24 and 26 synchronizes to the clock signal, and divides the count value by the time slot length to identify specific time slots 42. Processor 46 uses timer 52 to time the beginning and end of time slots 42, and particularly those time slots 42 that have been allocated to the node 22, 24 or 26 of interest.

Data port 54 represents the source of data that are transmitted away from a node 24 or 26 when the node 24 or 26 is an outermost node 38 of an inward communication path 36 or when an HAP node 22 of an outward communication path 34. Likewise, data port 54 represents the destination of data that are received at a node 24 or 26 when the node 24 or 26 is an outermost node 38 of an outward communication path 34 or a HAP node 22 of an inward communication path 36.

When a node 24 acts as a forwarding node 32, the source and destination of data is a buffer formed in memory 50. In addition, a portion of memory 50 is used to store a computer program 58 that instructs processor 46 how to carry out operations. For one node in WLAN 20, such as HAP node 22, computer program 58 is configured to include program segments for carrying out a resource allocation process. The resource allocation process is discussed below. Computer program 58 may be embodied in any suitable computer readable medium, including semiconductor, optical, magnetic, remote servers, or other memory structure.

The configuration of nodes 22, 24 and 26 in a manner compatible with IEEE 802.11 is desirable because such a configuration leads to reduced costs and reduces the likelihood that other IEEE 802.11 devices will significantly interfere. However, other protocols, including the Bluetooth protocol, may be utilized as well.

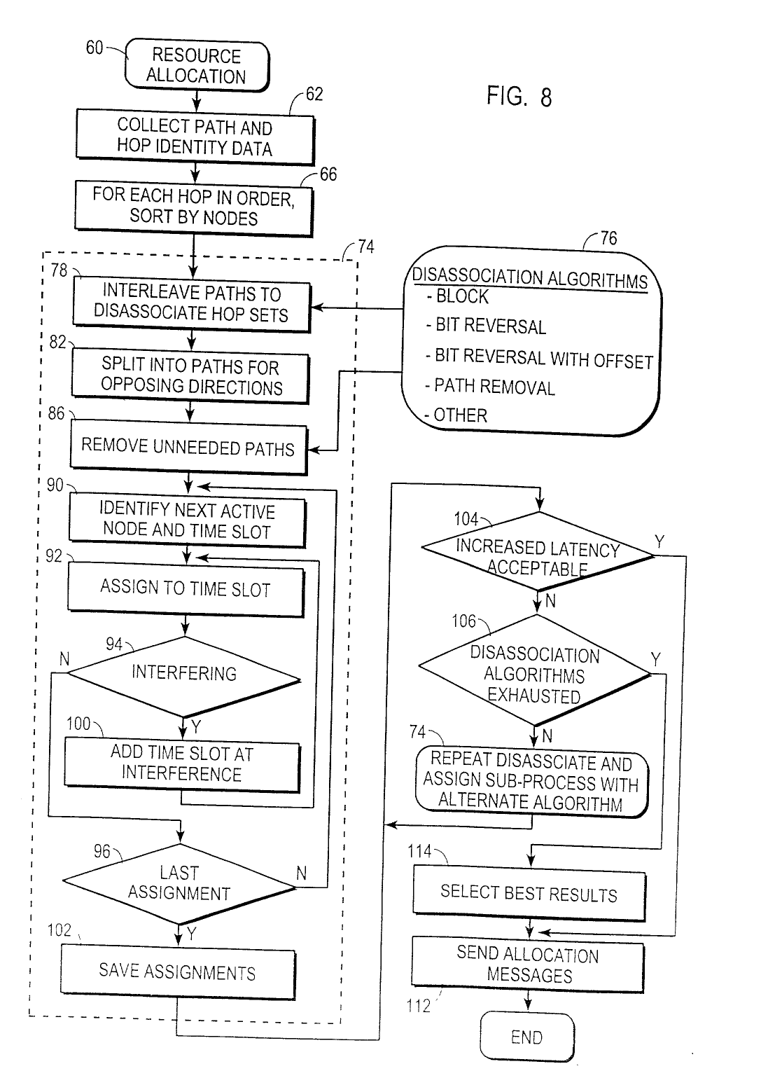

FIG. 8 shows a flow chart depicting a resource allocation process 60 carried out for WLAN 20. Process 60 includes a variety of tasks, each of which is performed in a manner well understood to those skilled in the art in response to various instructions from various segments of computer program 58 (FIG. 7). While process 60 may be carried out at any node in WLAN 20 or device in data communication with WLAN 20, HAP node 22 is one convenient location for performing process 60. Generally, process 60 is invoked to allocate time slots 42 to HAP node 22 and active nodes 24. Process 60 may be invoked at any time during the operation of WLAN 20 when a new allocation of time slots 42 may be required.

Process 60 includes a task 62, which is performed to collect path and hop identity data. FIG. 9 shows a table 64 depicting bi-directional path pairs 30 constructed in response to task 62. Referring to FIGS. 8 and 9, each bi-directional path pair 30 extending between HAP node 22 and the active nodes 24 of WLAN 20 is identified along with a O-hop path associated with HAP 22 alone. In table 64, one row is provided for each bi-directional path pair 30. HAP node 22 is not explicitly indicated since it is a common innermost node for all bi-directional path pairs 30. Otherwise, each hop 40 of each path pair 30 is identified. The notation “IN-?” represents an additional hop 40 beyond the outermost node 38 of each bi-directional path pair 30 that serves as an opportunity for inactive nodes 26 to communicate. No specific inactive node identity is indicated because any inactive node 26 may communicate at the indicated HAP node 22 or active node 24 at this opportunity. A conventional unscheduled medium access technique may be used during the inactive node opportunity.

In the top row of table 64, a 1-hop bi-directional path pair 30 is indicated, with the outermost node 38 of the bi-directional path pair 30 being active node AN-6 (FIG. 1). In place of a second hop for this 1-hop bi-directional path pair 30, an opportunity is provided for any inactive node 26 to communicate with active node AN-6, as indicated by the “IN-?” notation. Table 64 lists “X's” in hops beyond the inactive node 26 opportunities to indicate that no transmission or reception will be scheduled.

While collecting data during task 62, process 60 obtains data describing rate requirements for active nodes 24. This rate data may be provided by the active nodes 24 themselves in the nature of request messages. Alternatively, predictive processes (not shown) may be performed to predict when various active nodes 24 require higher or lower data rates. In response to this rate data, task 62 determines whether the data rate request can be fulfilled using a single bi-directional path pair 30.

If the data rate request cannot be fulfilled using a single bi-directional path pair 30, an additional bi-directional path pair 30 may be assigned, as indicated for active node AN-8 in table 64 and in FIG. 3. In some situations, a data rate requirement may indicate a data rate so low that no bi-directional path pair 30 is needed. In such situations, the node associated with such a low data rate requirement may be declared an inactive node, and no bi-directional path pair 30 identified therefore. Such a node will be able to continue communicating at a low data rate using provisions for inactive nodes 26.

After task 62, a task 66 sorts the bi-directional path pair data collected in task 62. FIG. 10 shows a table 68 depicting bi-directional path pairs 30 after the sorting of task 62 is performed. Referring to FIGS. 8 and 10, bi-directional path pairs 30 are sorted by active nodes 24, in hop order of precedence. In other words, bi-directional path pairs 30 having common 1-hop active nodes 24 are associated together in first-hop sets 70, then for each first-hop set 70, bi-directional path pairs 30 having common 2-hop active nodes 24 are associated together, and so on for the maximum number of hops accommodated by WLAN 20. First-hop sets 70 having active 1-hop nodes AN-1 and AN-4 in common are now associated together, as is second-hop set 72 having active 2-hop node AN-8 in common. Sorts may be performed in an ascending, descending or other order. Generally, the association of task 66 is performed to identify the bi-directional path pairs 30 that are likely to benefit from an upcoming disassociation task.

Following task 66, process 60 performs a disassociate and assign sub-process 74. In one embodiment, sub-process 74 may be performed repetitively in a programming loop using different disassociation algorithms 76. During each iteration of sub-process 74 a different disassociation algorithm 76 may be used.

Within sub-process 74, a task 78 is performed to interleave the bi-directional path pairs 30 previously associated together into hop sets 70 and 72 in task 66. The goal of task 78 is to distribute hop sets 70 and 72 substantially evenly throughout all of bi-directional path pairs 30. In other words, each member of each hop set 70 and 72 is desirably located as far as possible from all other members of its hop set 70 and 72. The disassociation of hop sets 70 and 72 is performed to allow the best opportunities for allocating time slots 42 to HAP node 22 and active nodes 24 without forming interfering situations.

The precise interleaving algorithm 76 followed in any iteration of task 78 is not a critical parameter in process 60. Any of a variety of conventional interleaving algorithms 76 may be used, including a block interleaving algorithm, a bit-reversal interleaving algorithm as taught in U.S. Pat. No. 5,949,769, entitled “Multirate Local Multipoint Data Distribution System,” a bit-reversal with offset algorithm, and the like.

FIG. 11 shows a table 80 depicting bi-directional path pairs 30 after interleaving in task 78. The exemplary results depicted in table 80 result from using a bit-reversal with offset algorithm. First-hop sets 70 having active 1-hop nodes AN-1 and AN-4 in common are now distributed substantially evenly as is second-hop set 72 having active 2-hop node AN-8 in common.

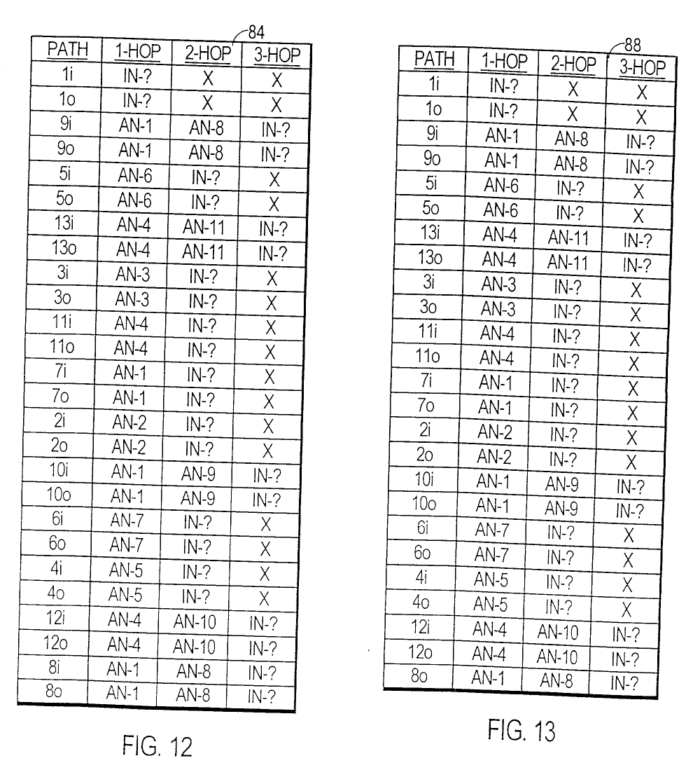

After task 78, a task 82 splits the bi-directional path pairs 30 into their constituent outward communication paths 34 and inward communication paths 36. FIG. 12 shows a table 84 that results from the splitting activity of task 82. To each path number, either an “o” or “i” has been appended to indicate either an outward communication path 34 or an inward communication path 36, respectively. Inactive node 26 opportunities “IN-?” are now defined for HAP node 22 and each active node 24, for both outward and inward communication with inactive nodes 26.

After task 82, a task 86 removes any unneeded communication paths 34 or 36. Paths may be unneeded to support asymmetrical data rates. For example, as depicted in FIGS. 5 and 9-12, a sufficiently greater data rate may be required for active node AN-8 to justify multiple bi-directional data paths 30. However, as shown in FIG. 5, the greater data rate may actually be needed only in one direction, such as the outward direction. In this situation, two outward communication paths 34 may be needed for active node AN-8, but not two inward communication paths 36. Accordingly, task 86 removes any unneeded communication path, such as an unneeded inward communication path 36 for active node AN-8. FIG. 13 shows a table 88 that depicts the removal of an unneeded communication path. In particular, table 88 differs from table 84 (FIG. 12) in that path 8i has been removed, leaving path 9i and paths 8o and 9o extending between HAP node 22 and active node AN-8.

After task 86, process 60 performs a programming loop to assign time slots 42 to active nodes 24 on a hop-by-hop basis, with one time slot 42 being assigned to each hop 40. Thus, a task 90 identifies an active node 24 and time slot 42 for which an assignment will be made. Following task 90, a task 92 makes the assignment in the consecutive allocation manner discussed above in connection with FIGS. 4-6. After task 92, a query task 94 detects whether the assignment made above in task 92 caused an interference situation, such as the one discussed above in connection with FIG. 6. So long as no interfering situation occurs, a query task 96 is performed to determine whether all assignments have been made. Unless all assignments have been made, program control loops back to task 90 to make the next assignment of a time slot 42 to an active node 24.

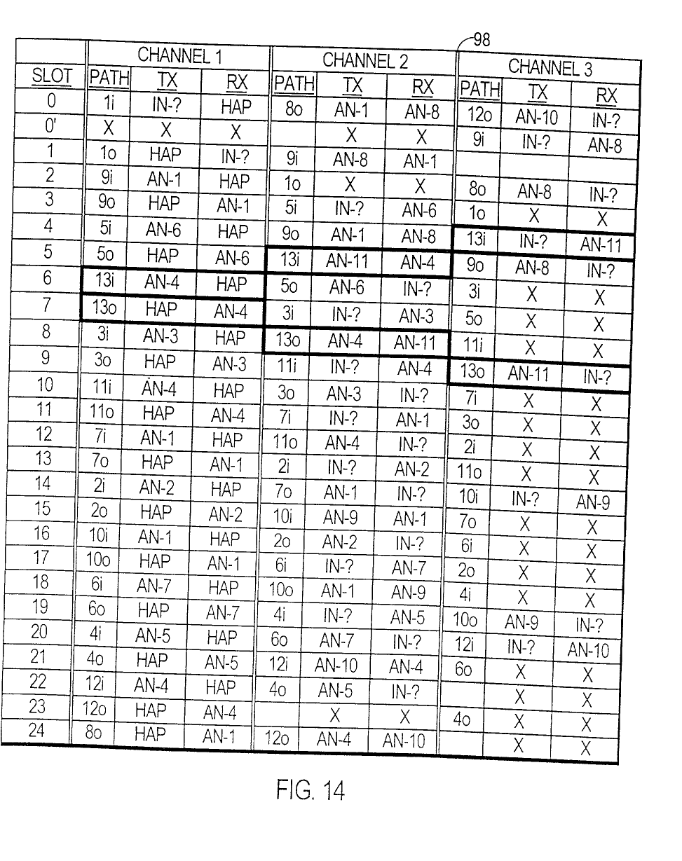

FIG. 14 shows a table 98 depicting outward and inward communication paths 34 and 36 after repetitively making the assignments of task 92 for all hops 40 for active nodes 24 in WLAN 20. Table 98 follows the stair-stepped patterns that result from consecutive time slot allocations along communication paths, as highlighted for outward and inward communication paths 13o and 13i. In particular, outward communication path 13o exists from time slot 7 through time slot 9, and inward communication path 13i exists from time slot 4 through time slot 6. Outward and inward communication paths 13o and 13i do not coexist.

Table 98 also indicates the results of an interference situation that originally occurred in connection with allocating the inactive node opportunities “IN-?” for active node AN-8. Referring to FIGS. 8 and 14, an interfering situation occurred around time slots 0 and 1 in the allocation of channel 3 for active node AN-8. During time slot 0, path 9i could have been scheduled to simultaneously receive over both channels 2 and 3 at node AN-8. Likewise, during time slot 1, path 80 could have been scheduled to simultaneously transmit in path 80 and in path 9i over channels 2 and 3 following a rigorous application of consecutive time slots to communication paths. When this interference situation was detected at task 94, a task 100 was then performed to add a time slot 42, depicted as time slot 0′, to cure the interference. Then path 9i was allowed to receive at active node AN-8 during time slot 0′, and path 8o was allowed to transmit from active node AN-8 during time slot 2. The latency period 44 (FIGS. 4-6) for path 9i was unaffected, but the latency period 44 for path 8o was increased by two time slots 42 above the minimum latency period as a result.

When task 96 determines that the last assignment has been made, a task 102 is performed to save all assignments of time slots 42 to active nodes 24 during this iteration of sub-process 74. Then, a query task 104 is performed to determine whether any added time slots, such as time slot 0′ depicted in table 98 (FIG. 14), or other increases in latency periods 44 yielded acceptable results. Task 104 may, for example, monitor the total of all latency periods 44 for all communication paths 34 and 36 in WLAN 20, and indicate acceptable results only if the total of all latency periods 44 is less than a predetermined threshold determined as a function of the number of hops scheduled for WLAN 20.

The adding of time slots and other increases in latency depicted in the example of FIG. 14 shows one solution for the general case. In specific cases, such as the simple example of FIG. 14, alternate solutions may be more acceptable. In one alternate solution, inactive node opportunities may be omitted to solve interference situations and avoid latency increases. In such situations, other inactive node opportunities may be provided from other active nodes. In another alternative embodiment, increased latency periods for inactive node opportunities may be given less weight than for active nodes in the analysis of task 104. Thus, a given amount of latency increase over the minimum may be acceptable when associated with inactive node opportunities, whereas it might not be acceptable if associated with outward and inward communication paths 34 and 36.

When task 104 determines that the amount of increased latency over the minimum possible is not acceptable, a query task 106 is performed to determine whether all disassociation algorithms 76 available to sub-process 74 have been exhausted. So long as additional disassociation algorithms are available, then sub-process 74 is repeated using a disassociation algorithm different from those attempted before.

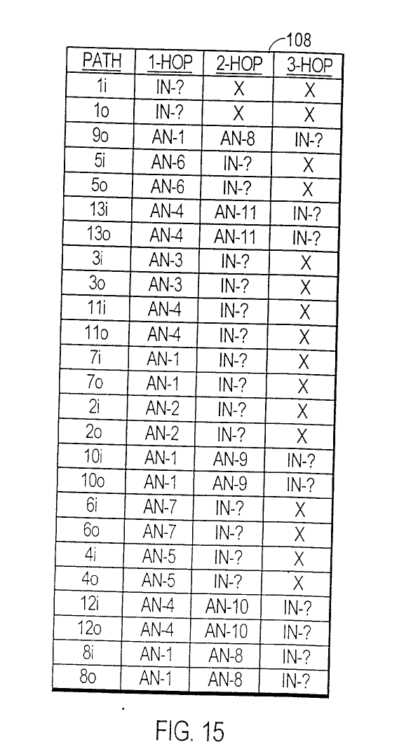

FIG. 15 shows a table 108 depicting the use of a different disassociation algorithm 76. In this particular example, table 108 is formed by using the same interleaving algorithm at task 78, but a different algorithm for path removal in task 86. In other examples, different algorithms may be used in task 78. Thus, table 108 depicts the results of task 86, and differs from table 88 discussed above (FIG. 13) by removing inward communication path 9i between active node AN-8 and HAP node 22 rather than the inward communication path 8i that was removed in the previous iteration of sub-process 74.

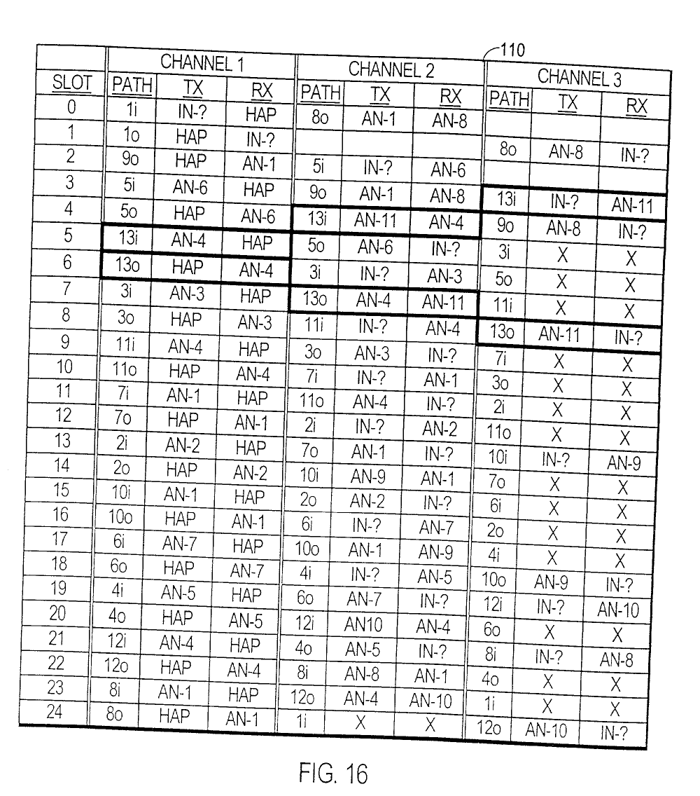

As a result of this iteration of disassociation and assigning sub-process 74, no interference situations were encountered, as illustrated in FIG. 16. FIG. 16 shows a table 110 in which thirteen outward communication paths 34 and twelve inward communication paths 36 have been assigned using a frame of only twenty five time slots 42. Every communication path 34 and 36 experiences the minimum latency period 44. Consequently, query task 104 will find this iteration of sub-process 74 as providing acceptable results and pass program control to a task 112.

Task 112 sends suitable allocation messages to active nodes 24. The allocation messages effectively convey the data presented in table 110 (FIG. 16). Each active node 24 is instructed during which time slots 42 to receive on which channels and during which time slots to transmit on which channels.

When query task 106 eventually determines that disassociation and assignment sub-process 74 has been performed a sufficient number of iterations so that all disassociation algorithms 76 have been exhausted, a task 114 is performed. Task 114 selects the best assignment set saved in the various iterations of task 102 from sub-process 74. The best results may be the results with minimum total latency, fewest coexisting outward and inward communication paths 34 and 36 of bi-directional path pairs 30, or the like. Following task 114, program control flows to task 112.

After task 112, process 60 ends. However, process 60 may be invoked again when needed to revise the assignments of time slots 42 to active nodes 24.

In summary, the present invention provides an improved multihop, multi-channel, wireless communication network with scheduled time slots. The multihop, multi-channel, wireless communication network to a large extent avoids the inefficiencies of unscheduled access by eliminating collision/backoff procedures and CTS/RTS signaling for a majority of the communications. The multihop, multi-channel, wireless communication network schedules time slots to minimize latency so that buffering requirements are likewise minimized and quality of service may increase. Time slots are consecutively allocated along communication paths to hold latency periods as close to the minimum latency as practical. Scheduled time slots are provided for specifically identified active nodes, but unscheduled time slots are allocated for use by unidentified inactive nodes.

Although the preferred embodiments of the invention have been illustrated and described in detail, it will be readily apparent to those skilled in the art that various modifications and adaptations may be made therein without departing from the spirit of the invention or from the scope of the appended claims. For example, not all data needs to flow to and from HAP node 22. Indeed, nothing prevents intra-network data transfers within WLAN 20. While the use of only one radio is desirable in one preferred embodiment because of reduced costs, other preferred embodiments may nevertheless use two transceivers and schedule time slots as taught herein. Moreover, those skilled in the art will appreciate that nothing requires all nodes in a network configured as taught herein to adhere to the teachings of the present invention. While some inefficiencies may result, some nodes and communication paths may be included that to not demonstrate consecutive time slot allocation, minimal latency, and the like.

What is claimed is:

1. A multihop, multi-channel, wireless communication network configured as a daughter network for coupling to a parent network, said communication network comprising:
a hub access-point (HAP) node configured to be coupled to said parent network and configured to engage in outward wireless communication; and
a plurality of active nodes configured to engage in said outward wireless communication with said HAP node over a plurality of outward communication paths, wherein said plurality of outward communication paths each includes at least two outward hops and uses at least two channels; wherein,
scheduled time slots are allocated to said active nodes for transmitting data packets over said plurality of outward communication paths, one time slot is associated with each outward hop, and said time slots are consecutively arranged along said plurality of outward communication paths.

2. A communication network as claimed in claim 1 wherein consecutive time slots are allocated to said active nodes in said outward communication paths beginning with a time slot allocated to said HAP node.

3. A communication network as claimed in claim 1 wherein each of said outward hops has two termini, with one of said two termini being at one of said active nodes.

4. A communication network as claimed in claim 1 additionally comprising at least one inactive node, wherein an unscheduled time slot is allocated to said active nodes for use in communicating with said at least one inactive node.

5. A communication network as claimed in claim 1 wherein said paths are interleaved so that said scheduled time slots for each of said active nodes are distributed substantially evenly.

6. A communication network as claimed in claim 1 wherein:
each of said plurality of outward communication paths exists for a latency period; and
said time slots are allocated to minimize a total of said latency periods for all of said outward communication paths.

7. A communication network as claimed in claim 1 wherein:
each of said active nodes includes only one transceiver;
said only one transceiver is configured to transmit or receive over a plurality of channels; and
each of said active nodes both transmits and receives over at least one of said plurality of channels.

8. A communication network as claimed in claim 1 wherein:
each of said HAP node and said plurality of active nodes is configured to engage in inward wireless communication over a plurality of inward communication paths, wherein said plurality of inward communication paths each includes at least two inward hops and uses said at least two channels; and
scheduled time slots are allocated to said nodes for transmitting data packets over said plurality of inward communication paths, one time slot is associated with each inward hop, and said time slots are consecutively arranged along each of said plurality of inward communication paths.

9. A communication network as claimed in claim 8 wherein:
consecutive time slots are allocated to said active nodes in said outward communication paths beginning with said HAP node; and
consecutive time slots are allocated to said active nodes in said inward communication paths beginning with outermost active nodes for said inward communication paths.

10. A communication network as claimed in claim 9 wherein:
each of said plurality of outward and inward communication paths exists for a latency period;
a bi-directional-path pair includes outward and inward communication paths that have a common outermost node; and
said time slots are allocated so that the number of coexisting bi-directional-path pair communication paths is minimized.

11. A communication network as claimed in claim 8 wherein:
said communication network additionally comprises at least one inactive node; and
at least two unscheduled time slots are allocated to said active nodes for use in communicating with said at least one inactive node, a first one of said two unscheduled time slots is allocated for transmission from said at least one inactive node, and a second one of said two unscheduled time slots is allocated for reception at said at least one inactive node.

12. A communication network as claimed in claim 1 wherein said HAP node and active nodes are operated in accordance with an IEEE 802.11 standard for wireless local area networks.

13. A communication network as claimed in claim 1 wherein:
a portion of said active nodes forwards data packets toward outermost active nodes of said outward communication paths; and
said portion of said active nodes receives, then transmits said data packets over different channels.

14. A multihop, multi-channel, wireless communication network configured as a daughter network for coupling to a parent network, said communication network comprising:
a hub access-point (HAP) node configured to be coupled to said parent network and configured to engage in inward wireless communication; and
a plurality of active nodes configured to engage in said inward wireless communication with said HAP node over a plurality of inward communication paths, wherein said plurality of inward communication paths each includes at least two inward hops and uses at least two channels; wherein,
scheduled time slots are allocated to said active nodes for transmitting data packets over said plurality of inward communication paths, one time slot is associated with each inward hop, and said time slots are consecutively arranged along said plurality of inward communication paths.

15. A communication network as claimed in claim 14 wherein consecutive time slots are allocated to said active nodes in said inward communication paths beginning with a time slot allocated to an outermost active node in each inward communication path.

16. A communication network as claimed in claim 14 wherein:
each of said plurality of inward communication paths exists for a latency period; and
said time slots are allocated to minimize a total of said latency periods for all of said inward communication paths.

17. A communication network as claimed in claim 14 wherein:
a portion of said active nodes forwards data packets toward said HAP node; and
said portion of said active nodes receives, then transmits said data packets over different channels.

18. In a communication network where a hub access-point (HAP) node communicates with a plurality of active nodes over a plurality of communication paths and wherein said plurality of communication paths each includes at least two hops and uses at least two channels, a method of allocating resources to said active nodes for use in forming said communication paths comprising:
collecting identity data which describes every hop of each communication path;
associating those ones of said communication paths having common first hops together in first-hop sets, and within each of said first-hop sets, ones of said communication paths having common second hops together to form second-hop sets;
disassociating said first-hop sets and said second-hop sets;
assigning time slots to said active nodes so that one time slot is associated with each hop, and said time slots are consecutively arranged along said communication paths; and
sending allocation data to said active nodes, said allocation data identifying assignments of said time slots to said active nodes.

19. A method as claimed in claim 18 wherein:
a bi-directional-path pair includes outward and inward communication paths that have a common outermost node;
said associating activity associates bi-directional-path pairs having active nodes in common; and
said method additionally comprises, after said disassociating activity, splitting said bi-directional path pairs into inward and outward communication paths.

20. A method as claimed in claim 18 wherein:
each of said plurality of communication paths exists for a latency period; and
said disassociating and assigning activities are configured so that said time slots are allocated to minimize a total of said latency periods for all of said communication paths.

21. A method as claimed in claim 18 wherein said assigning activity comprises:
detecting occurrences of interfering ones of said communication paths; and
adding time slots at said occurrences of said interfering ones of said communication paths.

22. A method as claimed in claim 18 wherein said collecting activity comprises:
collecting data which describes data rate requirements for said active nodes;
determining whether said data rate requirements can be fulfilled in a single path; and
specifying a plurality of paths as extending between said HAP node and ones of said active nodes for which said data rate requirements cannot be fulfilled in a single path.

23. A method as claimed in claim 18 wherein:
said HAP node may also communicate with inactive nodes; and
said assigning activity comprises assigning unscheduled time slots to said active nodes for use in communicating with said inactive nodes.

24. A method as claimed in claim 18 wherein:
said communication paths include inward communication paths over which data flows from said active nodes toward said HAP node and outward communication paths over which data flows from said HAP node toward said active nodes;
said assigning activity assigns consecutive time slots to said active nodes in said inward communication paths beginning with outermost nodes in said inward communication paths; and
said assigning activity assigns consecutive time slots to said active nodes in said outward communication paths beginning with said HAP node.

25. A multihop, multi-channel, wireless communication network configured as a daughter network for coupling to a parent network, said communication network comprising:
a hub access-point (HAP) node coupled to said parent network and configured to engage in outward and inward wireless communication; and
a plurality of active nodes configured to engage in said outward and inward wireless communication with said HAP node over a plurality of outward and inward communication paths, respectively, wherein each of said pluralities of outward and inward communication paths includes at least two hops and uses at least two channels; wherein,
scheduled time slots are allocated to said active nodes for transmitting data packets over said plurality of outward and inward communication paths, one time slot is associated with each hop, a first portion of said time slots is consecutively arranged along said plurality of outward communication paths beginning with said HAP node, and a second portion of said time slots is consecutively arranged along said plurality of inward communication paths beginning with outermost ones of said active nodes in said inward communication paths.

26. A communication network as claimed in claim 25 additionally comprising at least one inactive node, wherein a first unscheduled time slot is allocated to each of said active nodes for use in transmitting to said at least one inactive node and a second unscheduled time slot is allocated to each of said active nodes for use in receiving from said at least one inactive node.

27. A communication network as claimed in claim 25 wherein:
each of said communication paths exists for a latency period; and
said time slots are allocated to minimize a total of said latency periods for all of said communication paths.

28. A communication network as claimed in claim 25 wherein:
each of said active nodes includes only one transceiver;
said only one transceiver is configured to transmit or receive over a plurality of channels; and
each of said active nodes both transmits and receives over at least one of said plurality of channels.

29. A resource allocation computer program for use with a multihop, multi-channel, wireless communication network where a hub access-point (HAP) node communicates with a plurality of active nodes over a plurality of communication paths and wherein each of said plurality of communication paths includes at least two hops and uses at least two channels, said computer program comprising:
a first program segment configured to collect identity data which describes every hop of each communication path;
a second program segment configured to sort said communication paths so that said communication paths having common first hops are associated together in first-hop sets, and within each of said first-hop sets, said paths having common second hops are associated together to form second-hop sets;
a third program segment configured to interleave said first-hop sets and said second-hop sets;
a fourth program segment configured to assign time slots to said active nodes so that one time slot is associated with each hop, and said time slots are consecutively arranged along said communication paths; and
a fifth program segment configured to send allocation data to said active nodes, said allocation data identifying assignments of said time slots to said active nodes; wherein, said first, second, third, fourth, and fifth program segments are embodied in a computer-readable medium.

30. A computer program as claimed in claim 29 wherein:
a bi-directional-path pair includes outward and inward communication paths that have a common outermost node;
said second program segment sorts bi-directional-path pairs; and
said computer program additionally comprises a sixth program segment configured to split said bi-directional path pairs into inward and outward communication paths, said sixth program segment being invoked after said third program segment.

31. A computer program as claimed in claim 29 wherein:
each of said plurality of communication paths exists for a latency period; and
said third and fourth program segments are configured so that said time slots are allocated to minimize a total of said latency periods for all of said communication paths.

32. A computer program as claimed in claim 29 wherein:
said communication paths include inward communication paths over which data flows from said active nodes toward said HAP node and outward communication paths over which data flows from said HAP node toward said active nodes;
said fourth program segment assigns consecutive time slots to said active nodes in said inward communication paths beginning with outermost nodes in said inward communication paths; and
said fourth program segment assigns consecutive time slots to said active nodes in said outward communication paths beginning with said HAP node.
